(19) United States
(12) Patent Application Publication
(10) Pub. No.: US 2003/0075456 A1
(43) Pub. Date: Apr. 24, 2003

(54) Electrolytic treatment

(76) Inventors: John Collins, Sheffield (GB); Harry Fung, Chester (GB)

Correspondence Address: Westman Champlin & Kelly, International Centre Suite 1600, 900 Second Avenue South, Minneapolis, MN, 55402-3319, US

(21) Appl. No.: 10/181,166

(22) PCT Filed: Jan. 17, 2001
(86) PCT No.: PCT/GB01/00175

(51) Int. Cl. C25C 3/16; C25C 3/20; C25F 7/00; C25B 15/00; B23H 7/14

(52) U.S. Cl. 205/710; 204/230.2

(57) ABSTRACT

A method of treating a sample in contact with an electrolyte is disclosed. A non-sinusoidal alternating current (AC) comprising repeated waveform cycles is passed between the sample and the electrolyte. A number of advantageous forms of non-sinusoidal AC are disclosed. The method may, for example, be used in cleaning surface oxide layers from stainless steel.

The present invention relates to a method and apparatus for electrolytic treatment of a sample. In particular, but not exclusively, the invention relates to a method and apparatus for electrolytically removing material, such as oxide layers, from the surface of a metal sample, such as a stainless steel strip.

The heat treatment of a metal sample in the presence of oxygen generally gives rise to an oxidation reaction at the sample surface. The thickness, structure, corrosion resistance and mechanical properties of this oxide film or scale depend on a number of factors such as the metal or alloy composition, the composition of the surrounding atmosphere or fluid, and the temperatures and duration of the heat treatment.

Oxide layers formed during heat treatment in industrial processing of metals must often be removed before further processing or delivery to the customer. Oxide layers or scale left in place may spall off during further processing such as rolling, press forming or deep drawing. The hard oxide scale may be occluded into the metal surface or could damage tooling. The roughness of oxide layers may be unacceptable, resulting in poor dimensional tolerance and poor visual appearance, and corrosion resistance may be reduced.

A number of ways of removing undesirable oxide scale are known. Mechanical abrasion may be used, for example by grinding, by using high pressure water jets or by shot blasting. However, these processes are generally both slow and expensive. Immersion in a bath of molten salt is expensive. Chemical pickling by immersion of the metal in a bath of a corrosive fluid is commonly used, as is electrochemical pickling whereby the surface of the metal is treated electrolytically. Combinations of a number of different methods are frequently employed.

Stainless steels are particularly resistant to chemical and electrochemical pickling due to their inherent corrosion resistance, and due to the paucity of cracks and defects in the oxide layers on stainless steels, particularly with respect to carbon steels. The lack of defects reduces the transport of the pickling solution underneath the oxide scale where the main pickling mechanisms of undercutting by dissolution of the metal below the scale and mechanical scrubbing due to the evolution of hydrogen gas bubbles take place. Because of these problems, strong corrosive agents are normally used for the pickling of stainless steels, typically containing nitric and hydrofluoric acids. As the corrosion resistance and value of the stainless steel increases, so does the difficulty, time and cost involved in pickling to remove surface oxide scales.

Most commercial pickling of stainless steel is carried out chemically or by combining a direct current (DC) electrolytic treatment to condition the scale with a final chemical pickling stage. The electrolytic pickling of stainless steel using alternating current (AC) is also known.

It is thought that the superposition of a DC offset on to the AC improves the speed and effectiveness of pickling processes. However, to achieve such a current waveform at current levels sufficient for industrial electrolysis requires a DC supply protected by parallel capacitance from damage due to over current, over voltage and, particularly, reverse voltage of rectifying devices used in the power supply. For example, for a 10V and 20,000A system approximately 60F of capacitance would be required. This is a very large capacitance to implement at a typical driving frequency of about 50 Hz, and the capacitors would need to be able to carry a current of about 15,000A continuously without overheating. The core of the associated AC supply transformer would also need to be gapped and would need to be more substantial than usual to allow for the net DC bias of the current passing through the secondary windings. These factors would increase the cost and decrease the efficiency of the power supply.

Similar electrolytic treatments are used for cleaning grease, particles and other soiling agents from metals. Although solvents, detergent, caustic chemical and biological agents may be used, applications requiring rapid cleaning, such as metal strip production lines, generally use electrolytic cleaning in a caustic or neutral salt electrolyte using AC or DC. Other uses of electrolytic treatments of metals include the electrolytic etching of aluminium, especially for use in the printing industry, and galvanising and plating technologies.

Generally, it is desirable to maximise the effectiveness of electrolytic pickling and other electrolytic treatment processes, while minimising the time taken to perform the process, the electrical energy used, and the cost of the treatment apparatus and process consumables such as electrolyte chemicals and process waste treatment.

The present invention addresses these and other problems and disadvantages of the prior art.

Accordingly, the present invention provides a method of treating a sample by electrolysis, the sample being in contact with an electrolyte, the method comprising the step of passing a non-sinusoidal alternating current (AC) comprising repeated waveform cycles between the sample and the electrolyte. In this document, references to a sinusoidal alternating current are intended to include a sinusoidal AC incorporating an offset direct current. Furthermore, throughout this document, the term “alternating current” is not intended to be restricted to a sinusoidal alternating current. The use of expressions such as “non-sinusoidal AC” are merely for emphasis, and no waveform is intended to be limited to a sinusoidal form unless explicitly so stated.

Preferably, the mean current of the non-sinusoidal AC over one or more repeated waveform cycles is non zero.

Preferably, the magnitude of the mean current of the non-sinusoidal AC over one or more repeated waveform cycles has a value of at least 15% of the mean of the current magnitude over the same period. The mean of the current magnitude is calculated by averaging the current magnitude (disregarding direction of flow) over the relevant time interval.

Preferably, the peak magnitude of the non-sinusoidal AC in one direction has a value of at least 30% of the peak magnitude in the other direction.

Advantageously, the method of treating by electrolysis may be a method of removing surface material by electrolysis, such as pickling, cleaning, etching or polishing. Advantageously, the method may be applied to the treatment of a sample comprising stainless steel, such as a continuous stainless steel strip, or stainless steel tubing or castings. However, the method may be used for other electrolytic treatments.

Preferably, the waveform of the non-sinusoidal AC comprises an original AC waveform modified by reducing the rate of change of instantaneous current over at least a part of at least some of the repeated cycles of the original AC waveform.

More preferably, however, the original AC waveform is modified by setting the rate of change of instantaneous current to zero for at least a part of at least some of the repeated cycles of the original AC waveform. The original AC waveform may also or alternatively be modified by setting the instantaneous current to zero for at least a part of at least some of the repeated cycles of the original AC waveform.

In a preferred embodiment, the original AC waveform is modified by maintaining a zero current following a current zero point in the original AC waveform, for at least a part of at least some of the repeated cycles of the original AC waveform.

It should be understood that while methods according to the invention may be carried out by using power supply circuitry to modify a supplied current corresponding to the above-mentioned original AC waveform, the non-sinusoidal AC could be generated using other methods, such as direct synthesis from a DC supply, so as to achieve the same resulting non-sinusoidal AC waveform.

In another preferred embodiment the original AC waveform is modified by reversing the current direction for at least a part of at least some of the repeated cycles of the original AC waveform. The current may be reversed for some part of every waveform, only every second waveform or intermittently in other ways. The various ways of modifying the original waveform may be combined.

Preferably, the original AC waveform is one of a sinusoidal waveform and a square waveform. However, any other convenient waveform such as full-wave or half-wave rectified sinusoidal AC could be used. Preferably, the original AC waveform exhibits non-zero current in both directions and a mean current of zero. However, either the original AC waveform or the non-sinusoidal AC may be further advantageously modified by incorporating an offset direct current.

Advantageously, the direction of the mean current of the non-sinusoidal AC over one or more repeated waveform cycles may be periodically reversed, preferably with a period, that may be regular or irregular, of at least several seconds.

Advantageously, a preliminary DC current may be passed between the sample and the electrolyte prior to the step of passing the non-sinusoidal AC between the sample and the electrolyte. A preliminary DC current may also be passed between the sample and the electrolyte prior to the step of passing sinusoidal AC, with or without a DC offset, between the sample and the electrolyte.

Advantageously, the direction of the preliminary DC current may be reversed periodically.

Advantageously, the electrolyte may comprise between 10% and 40% sulphuric acid.

A number of embodiments of the invention will now be described, by way of example only, with reference to the accompanying drawings, of which:

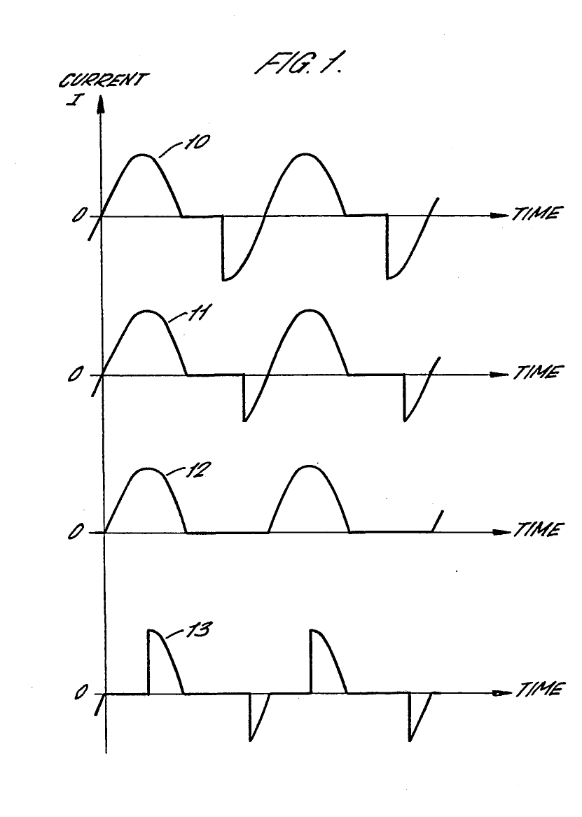

FIG. 1 shows a number of non-sinusoidal AC waveforms according to a first embodiment of the present invention;

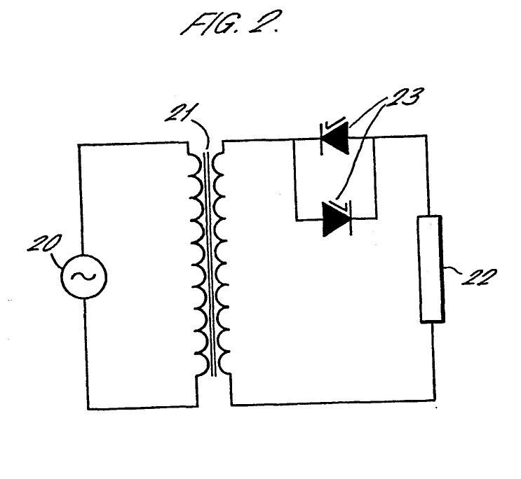

FIG. 2 presents a simplified schematic diagram of a power supply suitable for creating the modified AC waveforms illustrated in FIG. 1;

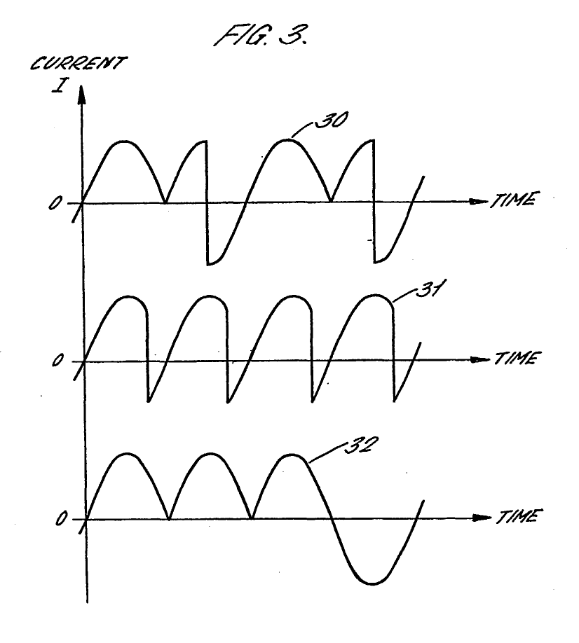

FIG. 3 shows a number of non-sinusoidal AC waveforms according to a second embodiment of the present invention;

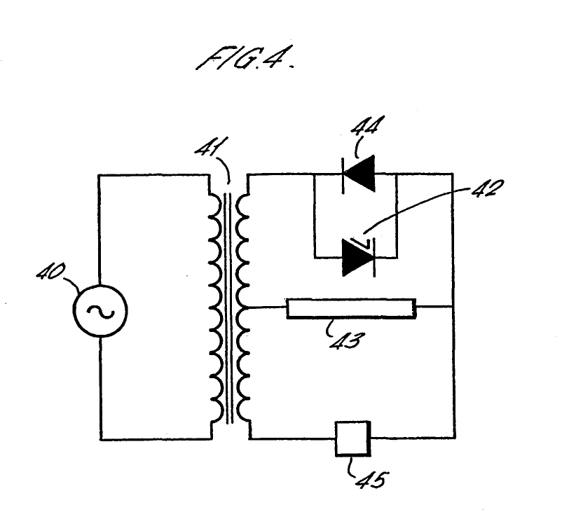

FIG. 4 presents a simplified schematic diagram of a power supply suitable for creating the modified AC waveforms illustrated in FIG. 3; and

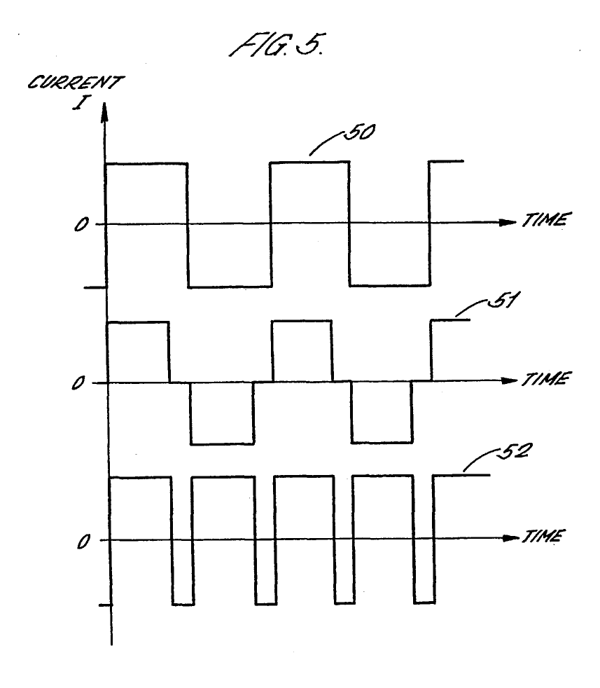

FIG. 5 shows a number of non-sinusoidal AC waveforms according to a third embodiment of the present invention;

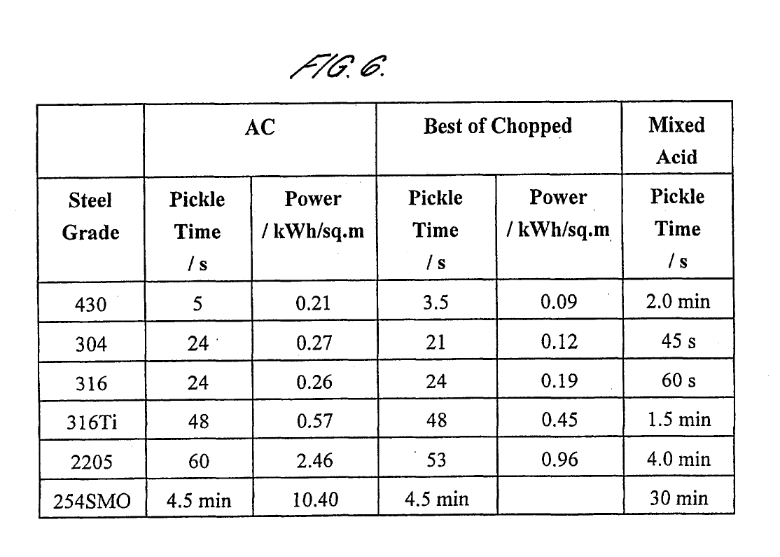

FIG. 6 is a table showing results of a number of pickling tests carried out according to a first embodiment of the invention on a number of grades of stainless steel;

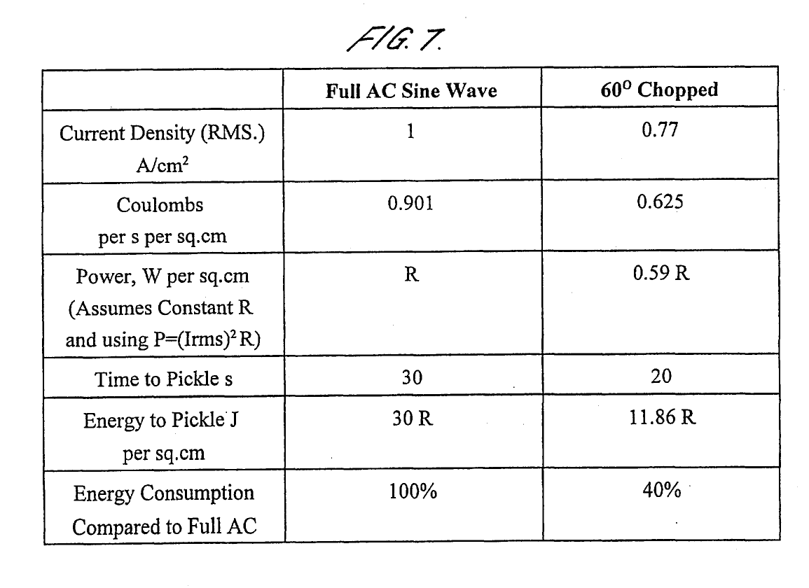

FIG. 7 is a table showing results of a number of pickling tests carried out according to a first embodiment of the invention on a number of grades of stainless steel;

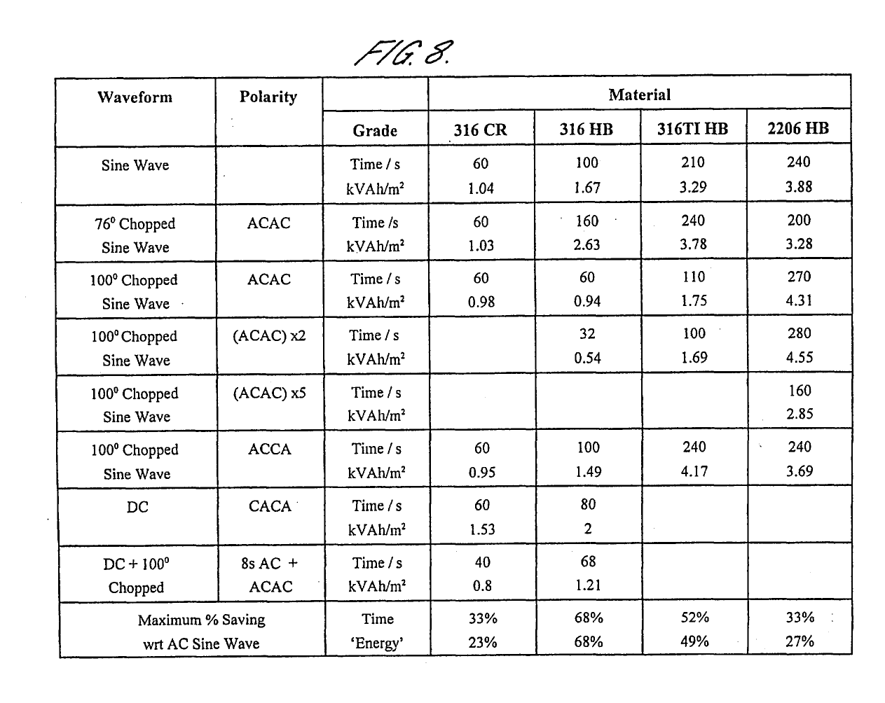

FIG. 8 is a table showing results of a number of pickling tests carried out according to a first embodiment of the invention on a number of grades of stainless steel;

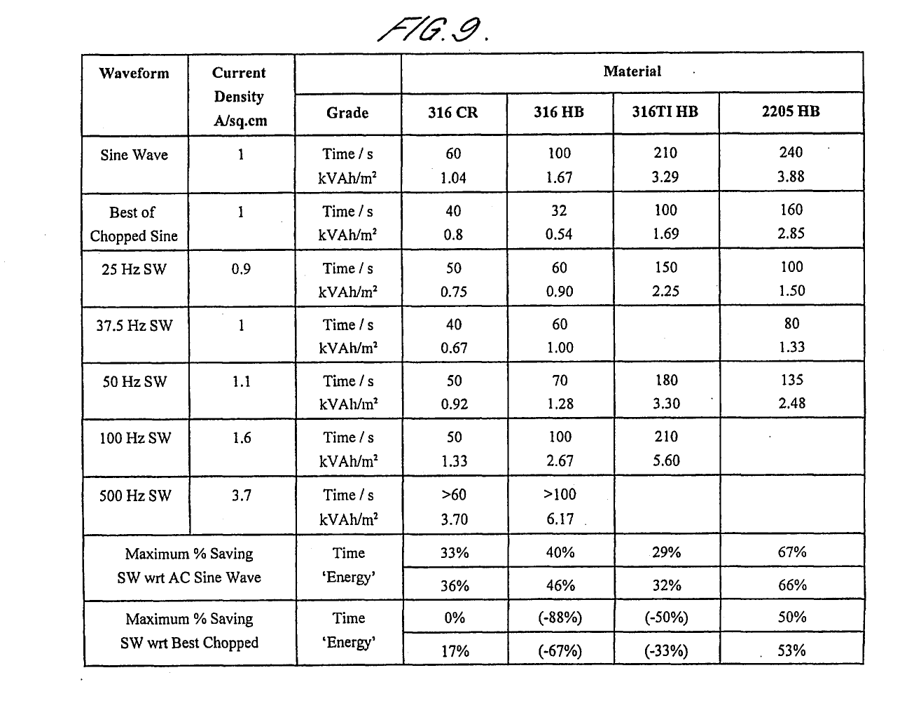

FIG. 9 is a table showing results of a number of pickling tests carried out according to a third embodiment of the present invention on a number of grades of stainless steel;

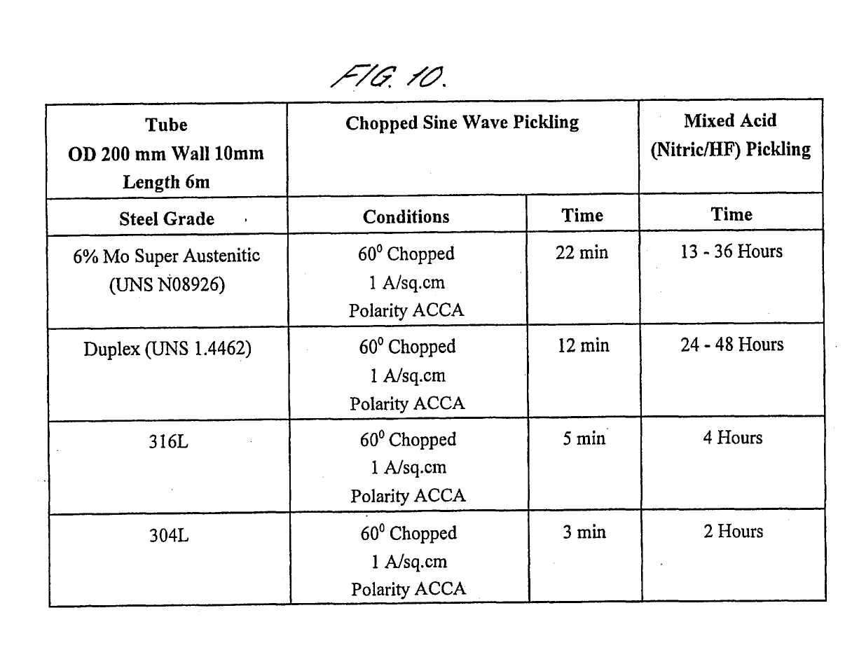

FIG. 10 is a table showing results of a number of pickling tests carried out according to an embodiment of the invention on samples of stainless steel castings;

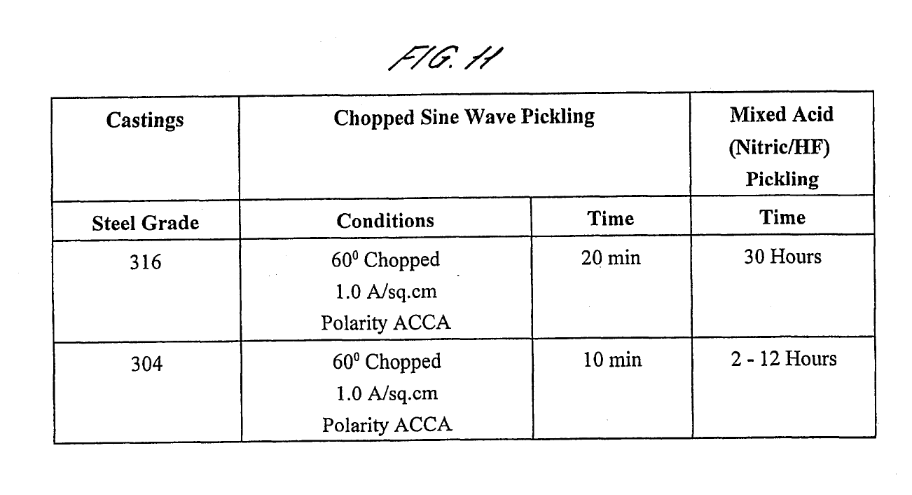

FIG. 11 is a table showing results of a number of pickling tests carried out according to an embodiment of the invention on samples of stainless steel tubing;

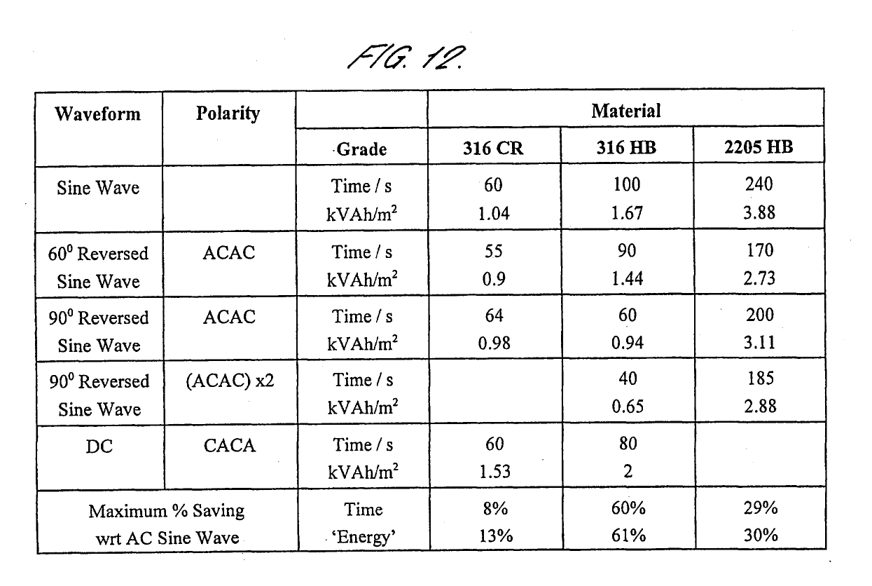

FIG. 12 is a table showing results of a number of pickling tests carried out according to a second embodiment of the invention on stainless steel samples.

Referring now to FIG. 1, there are shown a number of chopped current waveforms 10-13 based on original sinusoidal waveforms, according to a first embodiment of the invention, which may advantageously be used for electrolytic treatments such as pickling, and in particular for the pickling of stainless steel. Each of these chopped waveforms takes the form of a modified sinusoidal AC waveform.

The chopped waveforms shown in FIG. 1 are characterised in that one or more parts of the current waveform are chopped to a zero current, and in that the chopping is carried out to create an asymmetric waveform with a non zero average current over one or more cycles of the original AC waveform. In this document the phase angle of chopping is defined as the phase angle during which non zero current is conducted, within a chopped half cycle of the waveform. The direction of the mean current over one or more cycles determines whether a waveform is described as “anodic” or “cathodic”. Thus waveform 10 is a 90° anodic chopped waveform, waveform 11 is 45° anodic chopped waveform, 12 is a 0° anodic chopped waveform, while 13 is an anodic waveform chopped at 90° in the anodic phase and 45° in the cathodic phase.

Clearly, waveforms 10-13 are only a selection of the possible waveforms which may conveniently be created by current chopping and which may advantageously be used for electrolytic treatments such as pickling, and especially for the pickling of stainless steel. Waveforms in which the current is switched off at a non zero current point in the original AC waveform may be used, as may waveforms chopped between two non zero current points, which may be divided by a zero current point in the original AC waveform. While producing a chopped AC waveform for electrolytic treatments may be conveniently carried out using an originally sinusoidal AC waveform, advantageous waveforms may also be produced by chopping square AC, rectified sinusoidal AC or other waveforms.

Referring now to FIG. 2 there is shown a simplified schematic diagram of a power supply circuit suitable for driving an arrangement of electrodes in order to carry out an electrolytic treatment of a sample, such as the pickling of a stainless steel metal strip. By suitable control of the power supply components with control circuitry not shown in the figure, this power supply may easily be controlled to produce chopped current waveforms as described above.

The power supply comprises a source of alternating current, 20, which is connected across the primary winding of transformer 21. An electrolysis cell 22, comprising two complementary electrodes or sets of electrodes immersed in an electrolyte, has first and second electrical terminals. One of the electrodes may comprise the sample to be treated, or current may be impressed into the sample through the electrolyte. The first terminal of the electrolysis cell 22 is connected to one end of the secondary winding of transformer 21. Two thyristors 23 are connected in antiparallel between the second side of the secondary winding and the second terminal of the electrolysis cell. By providing carefully timed control signals to either one or both of the thyristors the current in either direction through the electrolysis cell 22 can be controlled.

Typically, the source of alternating current 20 in an industrial electrolysis application may be sinusoidal with a peak voltage of about 400V. the electrolysis cells of most industrial electrolysis operations, such as for the pickling of stainless steel, require current provided at only a few volts, but the cells may draw thousands or tens of thousands of amps and transformer 21 should be chosen or designed accordingly. Typically, an electrolysis cell will be driven by a desired voltage signal across the electrodes, so that the power supply will need to be able to supply the current required to maintain a particular voltage. For convenience, this document is drafted in terms of electrical currents and current waveforms, but it is to be understood that voltage could equally be used as the electrical variable.

Conventional thyristors cannot be used to turn off flowing current, so the circuit illustrated is limited to chopping the original AC waveform by maintaining zero current in the electrolysis cell starting from a zero current point in the original AC cycle, for some given period or phase angle.

Other switches may be used in place of one or both thyristors for more general modes of operation. Gate turn-off thyristors. (GTOs) may be used to turn off a flowing current, while insulated gate bipolar transistors (IGBTs) are able to conduct and switch current at higher frequencies. Other semiconductor switches that may be used in any of the power supplies described in this document include MOSFETs, or any other suitable transistors. At low frequencies one or more physical switches could be used, and for many desired current waveforms a diode may be substituted for one of the semiconductor switches, with some loss of flexibility.

It will be noted that to produce any of waveforms 10-12, one of the thyristors 23 shown in FIG. 2 may be replaced by a simpler and cheaper diode, as the anodic part of the waveform in each of these three examples remains unchopped.

Chopped waveforms have the disadvantage of causing harmonics and imposing a net DC level on the underlying power supply. However, these problems can be mitigated by running two identical power supply circuits in antiparallel on the same phase of the underlying power supply.

Referring now to FIG. 3, there are shown a number of sinusoidal current waveforms in which the current direction has been reversed in one or more parts of each or intermittent cycles of the original AC waveform, according to a second embodiment of the present invention. Reversed polarity AC waveforms, or reversed polarity AC waveforms in combination with chopped waveforms, may advantageously be used in electrolytic treatments, for example in pickling applications, and especially for the pickling of stainless steel.

Current waveform 30 is characterised in that the first 90° of the nominally cathodic part of each sinusoidal cycle has been reversed in polarity. Waveform 31 is characterised in that the last 33° of each anodic part of each sinusoidal cycle has been reversed in polarity, and in that all of the cathodic part of each sinusoidal cycle has been reversed in polarity except for the last 33°. This waveform exhibits double the fundamental frequency of the original supply. By providing appropriately timed current reversals, waveforms with both higher and lower fundamental frequencies than the original waveform can be generated. For example, waveform 32, having half the fundamental frequency of the original waveform, is characterised in that the cathodic part of every second sinusoidal waveform is reversed in polarity.

Clearly, waveforms 30-32 represent only a few of the many forms of polarity reversed waveforms that could be generated and used in electrolytic treatments. While generating a waveform for electrolysis by reversing the polarity of parts of a sinusoidal waveform may be particularly convenient, other original waveforms such as square waves or rectified sinusoidal AC could be used.

Polarity reversed waveforms have the advantage over chopped waveforms in that problems with harmonics and imposed net DC levels created in the underlying power supply are reduced.

Referring now to FIG. 4 there is shown a simplified schematic diagram of a power supply circuit suitable for driving an arrangement of electrodes in order to carry out an electrolytic treatment of a sample, such as the pickling of a stainless steel metal strip. By suitable control of the power supply components with control circuitry not shown in the figure, this power supply may easily be controlled to produce reversed polarity current waveforms as described above, as well as chopped waveforms.

The power supply comprises a source of alternating current 40, which is connected across the primary winding of a transformer 41. A thyristor 42 controllably allows current to flow from a first end of the secondary winding of the transformer 41 to a first terminal of electrolysis cell 43. Connected in antiparallel with the thyristor is a diode 44 that allows current to pass from the first side of the electrolysis cell 43 to the first end of the secondary winding. A gate turn-off thyristor (GTO) 45 controllably allows current to flow from the other end of the secondary winding of the transformer 41 to the first side of the electrolysis cell 43. Therefore, the first side of the electrolysis cell 43 is connected to the thyristors 42, the GTO 45 and diode 44. The second terminal of the electrolysis cell 43 is connected to a central tap into the secondary winding of the transformer.

As already described regarding the chopping power supply circuit shown in FIG. 2, other switching devices such as GTOs, IGBTs or mechanical switching devices may be used as appropriate in this or similar power supply circuits that are for producing current waveforms with regions of zero (chopped) current, or reverse polarity current. The circuit of FIG. 4 can only be used to switch or chop on one half of each cycle of the AC provided by the secondary winding of the transformer 41. Antiparallel switches without diodes on both halves of the secondary circuit would be required to allow any combination of chopping and polarity reversal.

When using a sinusoidal AC power source, creating chopped and reversed polarity sinusoidal based waveforms for electrolysis has the advantage over creating waveforms with DC or square wave components in that no power is lost through rectification of power from the sinusoidal source, and in that power need only flow through one semiconductor switch in series at anyone time. Power supply losses are therefore minimised. However, regular and modified square current waveforms, rather than waveforms based on sinusoidal AC, may be advantageously used in electrolysis applications such as pickling, and in particular for the pickling of stainless steel. Some examples of suitable square waveforms according to a third embodiment of the invention are shown in the graphs of FIG. 5, in which the vertical axis represents current and the horizontal axis represents time.

Square AC waveforms of a variety of forms may be generated from a DC power supply using a standard H-bridge. Such an H-bridge comprises a number of switches, for example IGBT devices each with an antiparallel diode, to control the polarity with which the DC supply is connected across the load, which in this case is an electrolysis cell. The bridge also allows the load to be isolated from the supply. Thus, square-wave AC with zero current intervals, for example waveform 51 of FIG. 5, and various waveforms with an anodic or cathodic current bias may be generated. Waveform 52, for example, is a square waveform wherein each cycle consists of current flowing in one direction for three times longer than in the other direction. Square waveforms with a current bias in one direction, ie with a net DC offset, are preferable for pickling applications.

The power supplies described above for providing a current source to an electrolysis cell may be designed to operate at a range of voltages and frequencies. However, voltages applied across electrolysis cells in commercial pickling applications generally fall in the range of a few volts, although several tens of thousand amps may be required. Electrolysis power supplies typically operate at the frequency of a convenient commercial electricity supply—typically 50 or 60 Hz, but other frequencies may equally be used.

The optimum choice of current waveform for a particular electrolysis application depends on a variety of factors. For the pickling of steels, the optimum choice of waveform may depend on the composition or grade of the steel sample, the heat treatment that the sample has undergone, the composition and structure of the oxide scale, the extent of any mechanical scale breaking already applied, and the desired balance between minimising energy consumption and minimising pickling time.

A number of common features of current waveforms found to be successful in the pickling of stainless steel have been identified. A high current density, typically between 0.1 and 10 A/cm² is preferable, as is a relatively high conductivity electrolyte.

The frequency of the applied current waveform should preferably be greater than 5 Hz, and ideally in the range 10-500 Hz.

It may be beneficial to change the applied waveform from time to time during the pickling process. An alternating current waveform with actual changes in current direction.is important, as are unequal proportions of positive and negative current, i.e. a non zero mean current over one or more AC cycles. A mean current over one or more complete waveform cycles with a value of at least 15% of the mean of the current magnitude over the same period is preferable, although at least 30% would be even more advantageous. Furthermore, the effectiveness of the pickling waveform is increased when the electrical potential at the cathode is high enough to cause hydrogen gas generation.

Preferably, the peak magnitude of the current in one direction in any one waveform cycle is at least 30% of the peak magnitude of the current in the other direction, although 50% would be even more advantageous. Alternating current with a DC bias, and sinusoidal AC with a reduced magnitude in one direction are found to be inferior to equivalent chopped waveforms.

The use in electrolysis applications of an AC waveform containing both anodic and cathodic portions, ie current flowing in both directions, certainly provides a number of advantages. The electrodes are continually depolarised, resulting in a lower electrical impedance and therefore lower power consumption. Hydrogen gas generation at the cathode provides mechanical scrubbing of the surface, assisting scale removal and increasing mass transfer at the metal/solution interface. Hydrogen/proton evolution may make the electrolyte at the interface highly alkali and the alternate acidic/alkali cycling prevents a corrosion resistant oxide film forming, or destroys any such existing film. Alternate anodic dissolution and cathodic gas evolution within the same AC waveform is superior in pickling effect to either of these effects alone or sequentially at a slower alternation period.

AC waveforms with a net current in one direction, i.e with a DC offset, can be described as having an overall polarity with respect to a particular electrode that is either anodic or cathodic. Clearly, for non-contact electrolysis systems, where the current passes into and out of the sample only by contact with the electrolyte, there must be a net zero flow of charge into, or out or the sample. For pickling applications using DC, a polarity reversal every few seconds is thought to reduce the required pickling time. For pickling and similar electrolytic treatments using the chopped, reversed polarity and square current waveforms described above, periodic polarity reversals by switching between AC waveforms with mean currents in opposite directions is also beneficial. It has been found that increasing the frequency or number of polarity reversals between net anodic and net cathodic waveforms in general decreases the required pickling time.

A known problem with electrolytic treatments using direct current. is that a treatment cycle ending with a cathodic sample surface polarity causes hydrogen embrittlement of materials such as steel. This problem does not arise with the chopped, reversed polarity and square waveforms described above, even when the waveforms exhibit a net anodic or cathodic bias.

While DC electrolytic pickling treatments are slower and use more energy over the complete pickling process than the AC treatments described above, DC pickling is very efficient during the initial stages of pickling. For example, DC pickling applied to cold rolled steels has been found to be more effective at cleaning the steel surface than AC waveforms for up to the first 10 seconds of pickling. Therefore, a combined approach of initial DC followed by AC pickling, whether using a regular sinusoidal waveform, an offset sinusoid or any other AC waveform, may often be a more time and energy efficient technique than use of either the DC or AC waveform alone.

Conveniently, electrolytic processes for the pickling of metals, and in particularly stainless steels, have employed electrolytes containing hydrochloric or a mixture of nitric and hydrofluoric acids. However, a number of benefits arise by using an electrolyte comprising between 10% and 40% sulphuric acid instead. Such an electrolyte is cheaper to produce, and is more easily regenerated. Moreover, pollution of waste water is more easily controlled that if nitric acid is used, and NO_{X} emissions are reduced or totally prevented. The use of a 10% to 40% sulphuric acid electrolyte also results in enhanced pickling rates and reduced energy consumption.

Some specific examples and experimental results regarding the electrolytic pickling of stainless steel samples will now be presented. Tests were performed on particular standard grades of stainless steel, following cold rolling, hot rolling and other processes, using various DC and AC waveforms and electrical supplies. The pickling times presented are an indication of the length of time required under a given set of conditions for all traces of scale to be removed from the relevant sample surface, as determined by a visual inspection.

The results of tests involving cold rolled stainless steel strip are presented in FIG. 6. Cold rolled metal strip has been cold rolled down to a given thickness, but in doing so has been rendered strong and brittle. In order to reduce its strength and increase its ductility, for sale or further processing, the cold rolled strip must be annealed. Annealing involves heating to about 70% of the absolute melting point temperature, which for a 304 grade stainless steel is about 1100° C. If any water or oxygen is present during annealing, it tends to create an oxide film on the steel surface. This film can be removed by electrolytic pickling.

The table of FIG. 6 presents pickling times for regular sinusoidal AC, chopped sinusoidal AC, and a non-electrolytic chemical pickling process, where each process has been applied to each of six steel grades. The electrolytic pickling processes were carried out with a sample surface current density of 1A/cm² and a current waveform frequency of 50 Hz. The electrolyte comprised 30% sulphuric acid held at a temperature between 55° C. and 65° C. The mixed acid non-electrolytic chemical pickling process was carried out in a fairly standard bath of about 10% nitric and about 4% hydrofluoric acid held at about 50° C. The pickling times for the electrolytic processes are much shorter than for the mixed acid non-electrolytic chemical process for all the tested grades of steel. The chopped waveform pickling process was in every case either faster than or the same speed as the regular sinusoidal AC process. The electrical power consumed in the pickling process in the form of electrode current is also shown in the table of FIG. 6. It will be seen that for every grade of steel the chopped AC process consumed less electrical power than the corresponding regular sinusoidal AC process.

The results shown in FIG. 6 for the chopped waveform pickling process include only the best result selected from a range of tested chopped waveforms. The best results for the 430, 304, 316, 316 Ti, 2205 and 254SMO steel grades were obtained using, respectively, 90° chopped ACCA, 45° chopped ACCA, 90° chopped (ACCA)×2, 90° chopped ACCA, 45° chopped ACAC and 45° chopped ACCA. “ACCA” refers to a pickling process comprising four periods, wherein the polarity of the waveform was reversed between the first and second and between the third and fourth periods. “A” and “C” denote periods of opposite direction average current flow. Similarly, “ACAC” denotes a pickling process of four periods with the waveform polarity reversed between each period, and (ACCA)×2 denotes a pickling process of eight periods of “ACCAACCA”. The same notation is used throughout the rest of this document.

The results of tests carried out on hot band steel samples are presented in the table of FIG. 7. Hot band steel has been hot rolled in an open atmosphere, and usually has a thick oxide scale and a substantial depth of chromium depletion underneath the oxide scale, which can also be removed by electrolytic pickling. The figure presents the results of pickling samples of 3 mm thick 302 grade hot band steel following a 10% cold reduction pickling to a consistent surface condition. One test used regular sinusoidal AC, and the other test used 60° chopped sinusoidal AC. It can be seen that the pickling time required using the regular AC is 30 seconds, whereas only 20 seconds are needed using the chopped AC. This saving in process time is in addition to a 60% saving in energy consumption.

The results of a selection of tests carried out on one cold rolled and three hot band steels using regular sinusoidal AC, a variety of different chopped sinusoidal AC waveforms, DC, and a combination of DC and chopped sinusoidal AC are shown in the table of FIG. 8. The first column of the table shows the angle of chopping of the sinusoidal waveform used, or indicates a different type of waveform. “DC” indicates direct current, with four periods of alternate polarity, and “DC+100°” indicates an eight second period of direct current divided into two periods of opposing polarity, followed by a period of 100° chopped sinusoidal waveform. The second column, headed “polarity” indicates the way in which the net polarity of each waveform was switched throughout each test. This notation has already been described above.

For each of the four grades of steel tested, the total required pickling time in seconds and the total electrical energy applied per area of sample surface is shown, although not all waveforms were applied to each sample. All samples were tested using a regular sinusoidal AC waveform, the results for which are shown in the top row. The best percentage savings in terms of time and energy with respect to the test using a regular sinusoidal AC are shown in the bottom row of the table. It will be seen that savings in:pickling time of between 33% and 68%, and savings in electrical energy of between 23% and 68% were obtained using chopped waveforms or combinations of DC followed by a chopped waveform.

The results of electrolytic pickling tests using square wave AC on one grade of cold rolled steel and three grades of hot band steel are compared, in the table of FIG. 9, to results using regular sinusoidal AC and the best result obtained using chopped sinusoidal AC. In the first column of the table “SW” indicates a test using square wave AC, with the square wave frequency in hertz indicated alongside. The current density applied to the sample surface is shown in the second column. The main body of the table shows the time and total electrical energy taken to obtain a completely clean sample. Not all samples were tested with all waveforms. The bottom four rows of results in the table indicate the best percentage savings in time and electrical energy made by using one of the tested AC square waveforms, as compared to the regular sinusoidal waveform, and as compared to the best of the chopped sinusoidal waveforms. For all grades of steel shown the square wave pickling was faster and more energy efficient than regular sinusoidal pickling. However, the best square wave pickling was inferior or equal in speed to the best chopped AC pickling process for three out of four of the grades, and inferior in energy use to the best chopped AC pickling process for two of the grades shown.

Tests were also carried out on the performance of chopped sinusoidal AC pickling on a number of grades of stainless steel in the forms of 200 mm outside diameter tubing and castings. The tube samples used had a wall thickness of 10 mm and a length of 6 m. During the final stages of manufacture the samples had only been slowly heat treated, so had relatively thick oxide scales. The duplex and super austenitic grades tested are very corrosion resistant, and require very long non-electrolytic chemical pickling times. The results of the tests are shown for the tube samples in the table of FIG. 10, and for the castings in the table of FIG. 11, and were obtained using a 35% sulphuric acid electrolyte at between 25° C. and 65° C. The electrolytic tests were carried out using chopped sinusoidal AC waveforms with the properties shown in the tables.

The results of some electrolytic pickling tests on stainless steel samples using reversed polarity waveforms are compared with similar tests using unmodified sinusoidal AC waveforms in the table of FIG. 12. The reversed polarity waveforms were created from a sinusoidal AC waveform by reversing the polarity, starting at one of the current crossings in each waveform cycle, and maintaining the reversed polarity for a particular phase angle. The phase angle for which the current reversal was maintained is shown in the first column of the table. The use of reversed polarity waveforms in the tests shown in the table resulted in savings in pickling time of between 8% and 60% and in savings in energy of between 13% and 61% with respect to the times and energies required using a sinusoidal AC waveform.

While some aspects of the described embodiments described, and the examples provided, have been related in particular to the use of electrolysis for the pickling of steels, the methods described are beneficial in a wide range of other electrolysis treatments. Although particularly advantageous for the treatment of materials that are corrosion resistant and difficult to etch such as stainless steels, nickel alloys, niobium alloys, titanium alloys, aluminium alloys and other materials where corrosion resistance is due to a surface oxide film, the methods may also be advantageously employed in general for the purposes of electrolytic cleaning, electroplating, electropolishing, deburring by etching, electrochemical machining, electrolytic etching, electrolytic surface texturing and selective surface etching using an inert or lower etch rate mask. Another suitable application of the invention is for the dissolution of metals into solution, for example for the purposes of forming or maintaining an electrolyte for use in electrolytic plating processes.

1. A method of treating a sample by electrolysis, the sample being in contact with an electrolyte, the method comprising the step of passing a non-sinusoidal alternating current (AC) comprising repeated waveform cycles between the sample and the electrolyte.

2. The method of claim 1 wherein the mean current of the non-sinusoidal AC over one or more repeated waveform cycles is non zero.

3. The method of claim 2 wherein the magnitude of the mean current of the non-sinusoidal AC over one or more repeated waveform cycles has a value of at least 15% of the mean of the magnitude of the current over the same period.

4. The method of any preceding claim wherein the peak current magnitude of the non-sinusoidal AC in one direction is at least 30% of the peak current magnitude in the other direction.

5. The method of any preceding claim wherein the method of treating by electrolysis is a method of removing surface material by electrolysis.

6. The method of claim 5 wherein the sample comprises stainless steel.

7. The method of any preceding claim wherein the waveform of the non-sinusoidal AC comprises an original AC waveform modified by reducing the rate of change of instantaneous current over at least a part of at least some of the repeated cycles of the original AC waveform.

8. The method of claim 7 wherein the original AC waveform is modified by setting the rate of change of instantaneous current to zero for at least a part of at least some of the repeated cycles of the original AC waveform.

9. The method of claim 8 wherein the original AC waveform is modified by setting the instantaneous current to zero for at least a part of at least some of the repeated cycles of the original AC waveform.

10. The method of claim 9 wherein the original AC waveform is modified by maintaining a zero current following a current zero point in the original AC waveform, for part of at least some of the repeated cycles of the original AC waveform.

11. The method of any of claims 7 to 10 wherein the original AC waveform is modified by reversing the current direction for at least a part of at least some of the repeated cycles of the original AC waveform.

12. The method of any of claims 7 to 11 wherein the original AC waveform is one of a sinusoidal waveform and a square waveform.

13. A method of claim of any of claims 7 to 12 wherein the original AC waveform is further modified by incorporating a DC offset.

14. A method as claimed in any preceding claim wherein the direction of the mean current of the non-sinusoidal AC over one or more repeated waveform cycles is periodically reversed.

15. A method as claimed in any preceding claim further comprising the step of passing a preliminary DC current between the sample and the electrolyte prior to the step of passing the non-sinusoidal AC.

16. A method as claimed in claim 15 wherein the direction of the preliminary DC current is reversed periodically.

17. A method as claimed in any preceding claim wherein the electrolyte comprises between 10% and 40% sulphuric acid.

18. A method substantially as herein described with reference to the accompanying drawings.

19. Apparatus arranged to carry out the steps of the method of any of claims 1 to 18.
